(19) United States
(12) Patent Application Publication
(10) Pub. No.: US 2013/0258682 A1
(43) Pub. Date: Oct. 3, 2013

(54) APPARATUS, SYSTEM AND METHOD FOR CONNECTING LINEAR LIGHT FIXTURES

(71) Applicants: Miguel A. Pino, Sunrise, FL (US); Dania Maccaferri La Spada, Weston, FL (US)

(72) Inventors: Miguel A. Pino, Sunrise, FL (US); Dania Maccaferri La Spada, Weston, FL (US)

(21) Appl. No.: 13/433,569

(22) Filed: Mar. 29, 2012

(51) Int. Cl. F21V 19/00; B23P 11/00

(52) U.S. Cl. 362/382; 29/428

(57) ABSTRACT

The present invention relates to an apparatus for installing a plurality of linear light fixtures. The apparatus of the present invention uses male connector and female electrical connectors and reduces on-site installation time and labor. The male connectors are positioned in a detachable housing unit that is connected to at least one light fixture to form a light fixture assembly which may be assembled off-site. The female connectors are retained in a connector bracket that forms part of a top cover assembly which is coupled to the electrical circuitry of the building structure on-site. The male-and-female connectors are thus manually connected on-site without the use of tools, thereby requiring only one on-site electrical connection from the female connectors within the top cover assembly to the power source of the building structure.

### BACKGROUND OF THE INVENTION

1. Field of the Invention

The present invention relates generally to linear lighting fixtures and more particularly to an apparatus and system for interconnecting linear lighting fixtures in order to reduce labor and facilitate on-site installation of linear light fixtures.

2. Description of Related Art

Linear light fixtures are often installed in non-residential buildings by suspending the light fixtures from a hanger from the ceiling. Often multiple linear light fixtures are installed adjacent to one another, such as in offices, or retail stores. These light fixtures may either be wired in series, or parallel. In series wiring, each fixture is fed the same current from the power source. In parallel wiring, each fixture is fed the same voltage from the power source. In order to reduce labor, the same wire from the building power circuit may be used to power two or more light fixtures in either series, or parallel.

Traditionally, on-site installation of two light fixtures to the same building circuit requires at least three electrical connections to be made-up. These three electrical connections include one connection each for each light fixture between the ceiling electrical disconnect from the building wiring circuit and each light fixture wiring for the first and second connections and one between the electrical disconnect and the building electrical circuit for the third connection. Making-up three electrical connections at the ceiling disconnect increases on-site labor and the potential for human error and injury. It would be advantageous to devise an apparatus and system for connecting linear light fixtures that requires the technician to make only one electrical connection on-site.

The prior art teaches the installation of multiple linear lighting fixtures. U.S. Pat. No. 2,988,633 (to W. B. Rosenfield) teaches installation of multiple linear lighting fixtures to a common assembly utilizing male and female connectors and mechanical connections.

It is also known to use male and female connectors for linear lighting systems as taught in U.S. Pat. No. 7,401,946 (to Laukhuf)

U.S. Pat. No. 7,753,551 (to Yaphe et al.) teaches a three-part connector with one part containing two female connecter and the second and third parts each being a male connector.

It would be beneficial to have a separate unit or apparatus that simplifies on-site installation of linear light fixtures; where the unit can be retrofitted to various manufacturers' light fixtures and where the unit can simply be plugged in and removed without the need for multiple on-site electrical connections and complex on-site installation.

The inventive concept set forth by the inventor is to reduce the number of on-site electrical connections required for installation of a plurality of linear light fixtures and facilitate installation of a plurality of light fixtures. The apparatus of the present invention connects two or more linear lighting fixtures on a single electrical junction box.

The invention enables the passage of electrical power in the form of an alternating current through two light fixtures wired in parallel. The inventive apparatus thus delivers electrical power, in the form of an alternating current to two light fixtures from the main alternating current power source.

The lighting fixtures with the corresponding housing attachments and bottom portion of the inventive apparatus may be assembled off-site and snapped onto a top cover at a later time by snapping the housing attachment to the top cover with one or more snap clips on each side of the housing attachments and top cover. Thus, the top cover of the inventive apparatus may be installed at a later time, on-site. Additionally, the inventive apparatus assembled off-site may be installed on-site to the connector bracket by mechanically and electrically connecting male and female connectors manually without the need for tools.

On-site, the electrical contractor will make one connection for both light fixtures from the unit. The contractor will connect a power cord with wire to the main alternating current power line. The on-site electrical connection is done below the conduit and top cover of the apparatus of the present invention.

The inventive concept provides that there are at least two ways to attach the unit to the junction box. The junction box may be closed with a standard steel top cover with a hole that is approximately a half inch in the center;

Alternatively, the inventive unit may have a canopy measuring approximately five inches in diameter attached to the top cover to close the junction box opening. The top cover is installed to the canopy and the canopy is attached to a top cover fastened to the junction box.

The apparatus of the present invention allows each light fixture in a dual light fixture assembly to be installed or removed separately. This is accomplished by utilizing a common connector bracket in which two female plug-in connectors are installed. Attachable to the connector bracket are two housing attachments, each housing attachment is mechanically attachable to a linear light fixture by a threaded mechanical joint, forming a light fixture housing assembly. Each housing attachment has a male plug-in connector to which the corresponding female connector is electrically connected. Each light fixture housing assembly is removably electrically attachable to one of the female plug-in connectors in the connector bracket. Above the connector bracket is the top cover for the connector bracket and a mechanical joint where the building circuit wiring is fed to the light fixtures and where the top cover may be mechanically connected to building support structure.

The connector bracket, top cover and mechanical joint above the connector bracket is mechanically installed to a building support structure. The female connectors on the connector bracket are electrically connected to a building wiring circuit passing through the mechanical joint.

Each light fixture may be supplied as the above described light fixture housing assembly. Then each light fixture housing assembly may be electrically and mechanically installed to the connector bracket by aligning the male plug-in connector on each housing attachment to the corresponding female attachment on the connector bracket and pushing each housing attachment into the connector bracket which engages the male and female connectors for the electrical connection and also engaging corresponding snap-on retainers on each housing attachment and the top cover of the connector bracket for the mechanical connection.

If the light fixtures need to be repaired, or replaced in the future, the light fixture housing assembly is easily removed and defective parts repaired, or replaced without affecting the building wiring circuit supplying power to the light fixture.

An advantage of the apparatus of the present invention is that it need not be integrated into the light fixture and can be sold as a separate unit.

Another advantage of the apparatus and method of the present invention is that it is waterproof and suitable for indoor or outdoor installation.

Yet another advantage of the apparatus of the present invention is that it can be retrofitted to suit a particular manufacturer's linear light fixtures.

Still another advantage of the apparatus of the present invention is that the wiring, power cord and connectors are internal to the unit. The inventive unit provides allows for the connection of a plurality of linear light fixtures while obviating the use of electrical rigid or flexible conduit pipes

An object of the invention is to increase safety of on-site installation of multiple linear light fixtures and reduce the risk of damage to the fixtures.

An object of the apparatus and method of the present invention is to reduce on-site installation time of multiple linear light fixtures and eliminates the need for on-site electrical hard wiring.

Another object of the apparatus and method of the present invention is that the unit can be plugged in and removed without requiring the use of wrenches or additional hardware.

### BRIEF DESCRIPTION OF THE DRAWINGS

FIG. 1 is an exploded view of the apparatus of the present invention.

FIG. 2 is a front view of the apparatus of the present invention in connection with two linear light fixtures

FIG. 3A illustrates on site installation of a first light fixture assembly to the top cover assembly.

FIG. 3B illustrates on site installation of a second light fixture assembly to the top cover assembly.

FIG. 4 is a front view of the top cover to junction box installation.

FIG. 5 is a cutaway view of the wiring in connection with the male and female connectors of the apparatus of the present invention.

FIG. 6 is a front view of the assembled apparatus of the present invention

FIG. 7 is a top view of the apparatus of the present invention.

FIG. 8 is a cross sectional view of the apparatus of the present invention.

### DETAILED DESCRIPTION OF THE INVENTION

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

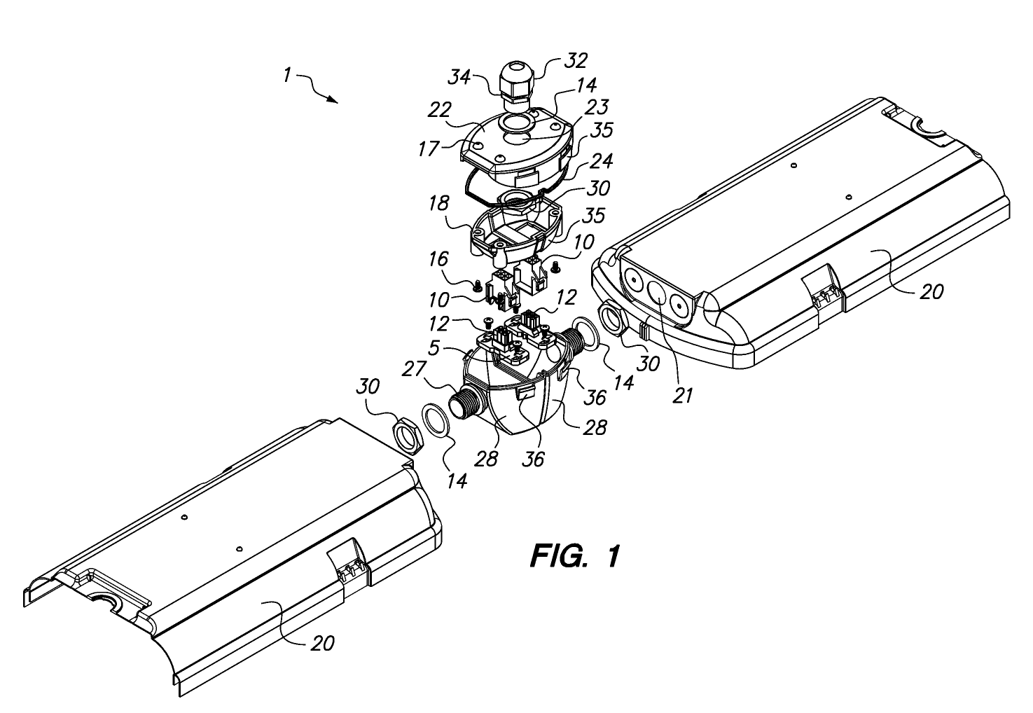

As illustrated in FIG. 1, an embodiment of the present invention is directed toward an apparatus 1 for installing a plurality of lighting fixtures 20 at an on-site location. FIG. 1 illustrates a dual light fixture installation system. However, the inventive concept is not limited to dual light fixtures, but may apply more generally to a plurality of hating fixtures. The light fixture installation apparatus 1 illustrated in FIG. 1 connects two light fixtures 20. The light fixtures 20 connect to the installation apparatus via threaded studs 27 protruding from either end of a housing attachment 28 of the apparatus 1. The housing attachment 28 includes threaded studs 27 which protrude from a first and second side of the housing attachment 28. The threaded studs 27 of the housing attachment 28 are inserted through holes 21 in each light fixture 20. Conduit lock nuts 30 and gaskets 14 which secure to the studs 27 are utilized to form a watertight mechanical joint to secure the light fixtures 20 to the inventive apparatus 1 via the housing attachment 28 as illustrated, in FIGS. 1-3. As illustrated in FIG. 1, the apparatus 1 includes at least two male connectors 12 installed within the housing attachment 28. As shown in FIG. 1, support means 5 secure the male connectors 12 within the housing attachment 28.

As illustrated in FIGS. 1, 2 and 8, female connectors 10 removably connect with the male connectors 12. A connector bracket 18 receives the female connectors 10. As illustrated the connector bracket 18 is affixed to a top cover 22 of the apparatus 1. A gasket 24 is positioned between the top cover 22 and connector bracket 18. The connector bracket is located above the housing attachment 28 and below the top cover 22. Thus the female connectors 10, top cover 22, gasket 24 form a top cover assembly

Referring to the Figures, the top cover 22 is affixed to the connector bracket 18 using bolt screws 17 or other fastening means. The gasket 24 provides a watertight seal between the connector bracket 18 and top cover 22. The top cover 22 and housing 28 include interlocking snap clips 35, 36. The snap clips 36 of the housing 28 engage the snap clips 35 on the top cover 22 to removably affix the top cover 22 to the housing 28.

In one embodiment of the invention, as illustrated in FIG. 4, a canopy 38 is installed above the top cover 22. The canopy 38 may be rotatable installed to a junction box 37 by rotating the canopy 38 ninety degrees relative to a cover of the junction box 39 to interlock the canopy 38 to the junction box cover 39. As illustrated in FIG. 4, the junction box cover 39 is secured by screws 16 to a standard junction box 37. Referring to FIGS. 1 and 4, the canopy 38 is attached to the top cover 22. A mechanical joint comprising a gasket 14, watertight conduit 34 and conduit nut 32, connects the top cover 22 to the top cover of the junction box cover 39. In an alternate embodiment, in lieu of using the canopy 38, a junction box 37 may be directly installed to the top cover 22.

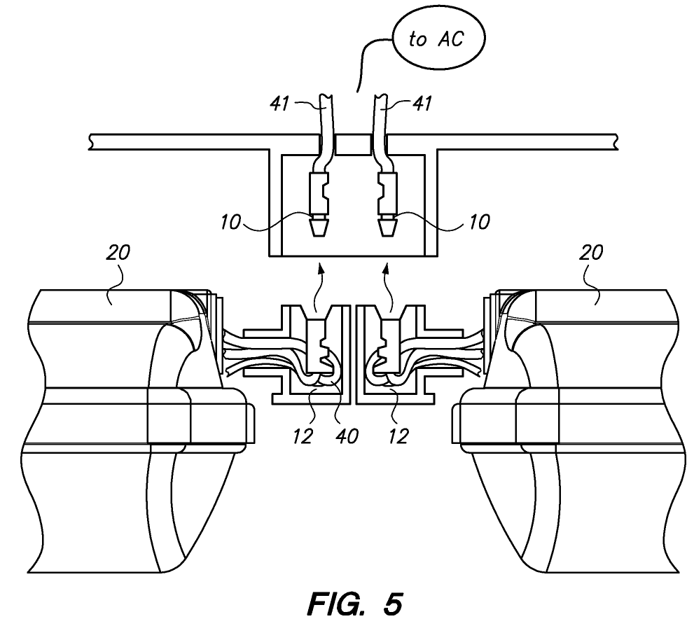

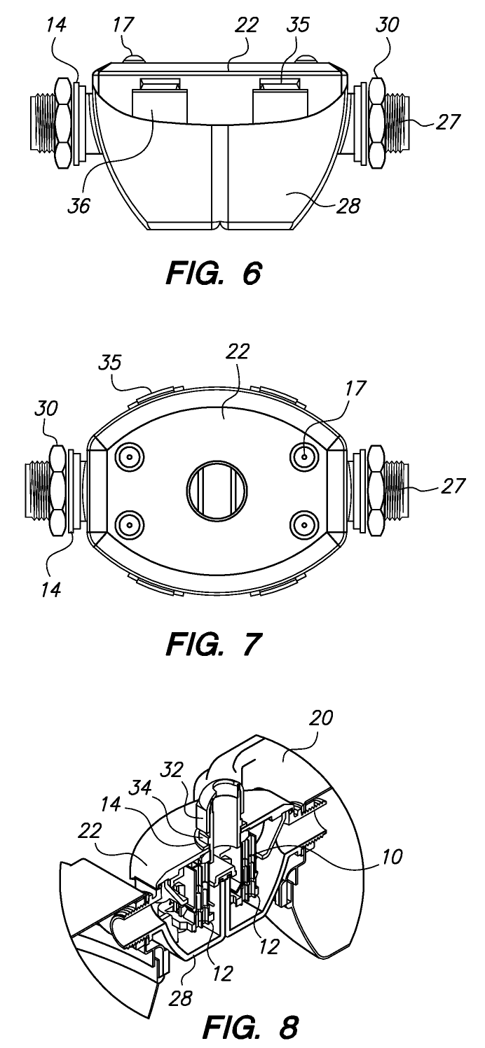

Wiring 40 within the light fixtures 20 is electrically coupled with the male connectors 12 as shown in FIG. 5. Referring to FIG. 5, the male connectors 12 are connected to the female connectors 10 thereby creating an electrical connection that passes from the female connectors 10 to the male connectors 12. The female connectors 10 are in electrical connection to the internal wiring 41 of a power source beyond the ceiling in the building structure. In a preferred embodiment, the wiring 41 is passed through a junction box 37 to the female connectors 10. The electrical connection between the female connectors 10 and the internal wiring 41 is made on-site.

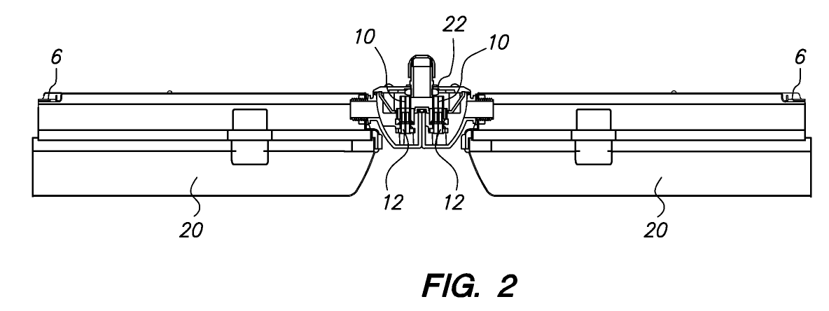

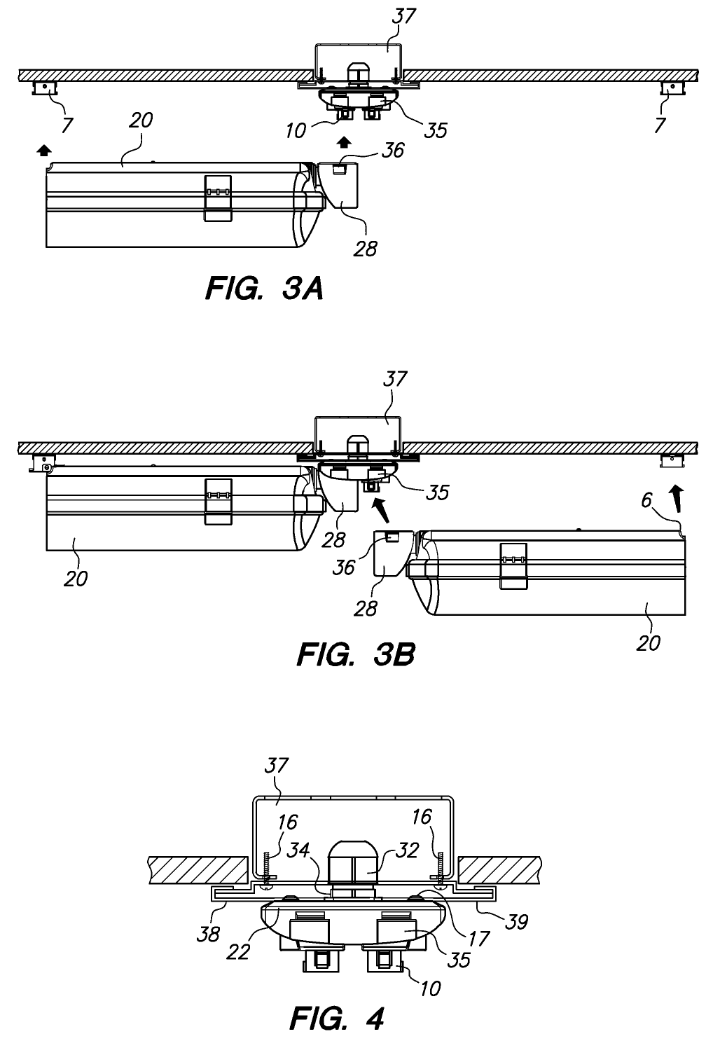

Referring to FIGS. 3A and 3B, the light fixtures 20 may be affixed to the housing attachment 28 off-site as an assembly for each light fixture 20 as described above. On-site, the electrical contractor will make one electrical connection by connecting the top cover assembly including the top cover 22 and female connectors 10 to the electrical wiring 41, of the building structure. The light fixture assembly, including the light fixture 20, housing 28 and male connector 12 is then coupled to the top cover assembly by connecting the male 12 and female 10 connectors. The light fixtures 20 are mounted to the ceiling using snap clips 6, 7 or other fastening means as shown in FIGS. 2, 3A and 3B.

In an alternative embodiment, a standard linear light fixture 20 is affixed to the housing 28 of the apparatus of the present invention 1 by mounting dual light fixtures 20 on opposing sides of the housing 28 as illustrated in FIGS. 1 and 2. In a preferred embodiment, the housing 28 includes two sections as shown in FIG. 1. The two sections of the housing 28 are corresponding mirror images that interconnect in a snap fit or other type of mechanical engagement as is known in the art.

Male connectors 12 are positioned and secured to a support means 5 within the housing 28. In a preferred embodiment, one male connector is secured within one half of the housing 28, while a second male connector is secured within the corresponding half of the housing 28 as shown in FIGS. 1, 2, 5 and 8.

Referring to FIG. 5, wiring 40 from the light fixture 20 is connected to the male connectors 12 to establish an electrical connection as is known in the art. Two light fixtures 20 may be connected off-site to the housing 28 as shown in FIG. 3B. Alternatively, a single light fixture 20 may be installed to one half of the housing 28 as shown in FIG. 3A. The single light fixture 20 affixed to the one half of the housing 28 forms an assembly which may later be joined to a corresponding assembly which includes the other half of the housing 28 affixed to another lighting fixture 20.

The female connectors 10, connector bracket 18, gasket 24 and top cover 22 are joined to form a top cover assembly. The connector bracket 18 retains the female connectors 10, while the gasket 24 is positioned between the connector bracket and top cover 22. The connector bracket 18 is secured to the top cover 22 using fastening means, such as bolt screws 17. The top cover 22 includes an aperture 23 for receiving a watertight conduit nut 34 which is secured by a conduit lock nut 32. A gasket 14 surrounds the aperture 23 and is positioned between the watertight conduit nut 34 and the top cover 22. The top cover assembly is connected to the junction box as shown in FIGS. 3A, 3B and 4. In an alternative the top cover assembly may be installed to a canopy 38 above the top cover 22 with the canopy 38 installed to a junction box 37.

Thus, the male connectors 12 within the housing 28 of the light fixture assembly, are connected to the female connectors 10 of the top cover assembly on-site as illustrated in FIGS. 3A and 3B. The snap clips 35 of the top cover 22 interlock with the snap clips 36 of the housing 28 to enclose the apparatus of the invention into a single unit

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus for interconnecting linear light fixtures comprising:
a top cover assembly including, a top cover having a central opening generally positioned at a midpoint of the top cover on a top surface and along a horizontal plane of the top cover, fastening means aligned along a perimeter of the top cover on a side surface of the top cover substantially perpendicular to the top surface of the top cover, a plurality of apertures positioned on the top surface of the top cover, at least two female connectors, a connector bracket for receiving the at least two female connectors within an interior of the connector bracket, a watertight gasket intermediate to the connector bracket and top cover for providing a watertight seal between the connector bracket and top cover and fastening means for mounting the connector bracket to the top cover.

2. The apparatus of claim 1 further including, a housing structure having a threaded stud protruding from a side wall of the housing, fastening means aligned along a perimeter of the housing structure, positioned substantially at a perpendicular to a bottom surface of the housing structure and wherein the fastening means of the housing structure are positioned to engage at least one of the fastening means aliened along the perimeter of the top cover to achieve a snap fit interlocking engagement therewith; a male connector positioned within the housing structure for mating engagement and electrical coupling with a female connector of the top cover assembly and fastening means for mounting the male connector to a support means within the housing structure.

3. The apparatus of claim 1 further including, a housing structure having a first threaded stud protruding from a first side wall of the housing structure and a second threaded stud protruding from a second side wall of the housing structure, fastening means aligned along a perimeter of the housing structure, positioned substantially at a perpendicular to a bottom surface of the housing structure and wherein the fastening means of the housing structure are positioned to engage the fastening means aligned along the perimeter of the top cover to achieve a snap fit interlocking engagement; at least two male connectors positioned within the housing structure for mating engagement and electrical coupling with the female connectors of the top cover assembly and fastening means for mounting the male connectors to a support means within the housing structure.

4. The apparatus of claim 1 further including a gasket positioned over and around the central opening of the top cover, a watertight conduit intermediate to the gasket and fastening means for securing the watertight conduit to the top cover to form a watertight mechanical joint.

5. The apparatus of claim 4 wherein the mechanical joint connects the top cover to a junction box at an installation site.

6. The apparatus of claim 5, further comprising a canopy attachable to the top cover and connector bracket with fasteners and wherein the canopy is rotatably engagable to the junction box.

7. The apparatus of claim 1 wherein the fastening means for securing the watertight conduit to the top cover is a conduit nut.

8. The apparatus of claim 3 wherein the housing structure comprises a first housing segment and a second corresponding housing segment and wherein the second corresponding housing segment is a substantially identical mirror image of the first housing segment.

9. The apparatus of claim 2, further including a light fixture having an aperture for receiving the threaded stud of the side wall of the housing and wherein wiring within the light fixture is electrically coupled to the male connector.

10. The apparatus of claim 3, further including a first light fixture having an aperture for receiving the first threaded stud of the first side wall of the housing and a second light fixture having an aperture for receiving the second threaded stud of the second side wall of the housing and wherein wiring within the first light fixture is electrically coupled to a first male connector and wiring within the second light fixture is electrically coupled to a second male connector.

11. A method of interconnecting linear light fixtures at an installation site comprising the steps of:
(a) providing a top cover assembly including, a top cover having a central opening generally positioned at a midpoint of the top cover on a top surface and along a horizontal plane of the top cover, fastening means aligned along a perimeter of the top cover on a side surface of the top cover substantially perpendicular to the top surface of the top cover, a plurality of apertures positioned on the top surface of the top cover, at least two female connectors, a connector bracket for receiving the at least two female connectors, a watertight gasket intermediate to the connector bracket and top cover for providing a watertight seal between the connector bracket and top cover and fastening means for mounting the connector bracket to the top cover, a gasket positioned over and around the central opening of the top cover, a watertight conduit intermediate to the gasket and fastening, means for securing the watertight conduit to the top cover to form a watertight mechanical joint,
(b) connecting the top cover assembly to a power source within a building structure and electrically coupling wiring from the power source to the at least two female connectors;
(c) providing a light fixture assembly including a housing structure having a threaded stud protruding from a side wall of the housing, fastening means aligned along a perimeter of the housing structure, positioned substantially at a perpendicular to a bottom surface of the housing structure and wherein the fastening means of the housing structure are positioned to engage at least one of the fastening means aligned along the perimeter of the top cover to achieve a snap fit interlocking engagement therewith; a male connector positioned within the housing structure for mating engagement and electrical coupling with a female connector of the top cover assembly and fastening means for mounting the male connector to a support means within the housing structure a light fixture having an aperture for receiving the threaded stud of the side wall of the housing and wherein wiring within the light fixture is electrically coupled to the male connector; and
(d) connecting the male connector to the female connector.

12. The method of claim 11, further including the step of connecting the top cover assembly to a junction box, wherein the mechanical joint connects the top cover to a junction box canopy.

13. The method of claim 12 wherein the canopy is rotatably engagable to the junction box.

14. A method of using a light fixture installation kit, the method comprising the step of procuring a plurality of light fixtures and a light fixture installation kit capable of allowing the plurality of light fixtures to be installed in parallel to a junction box and requiring only a single manual electrical connection to be made-up at an installation location of the junction box, the light fixture installation kit comprising:
a) a plurality of housing attachments, each of the plurality of housing attachments capable of attaching to a light fixture, a male connector housed within each of the plurality of housing attachments, a connector bracket attachable to each of the housing attachments, a plurality of female connectors attachable to an interior of the connector bracket, wherein the male connector housed within each of the plurality of housing attachments is mechanically and electrically connectable to the plurality of female connectors, the male connector housed within each of the plurality of light fixture housing attachments capable of being electrically connected to a light fixture,
b) each of the plurality of housing attachments having a stud protruding from a side portion of each housing attachment, a light fixture capable of being installed on each stud, a gasket and a nut installed on each stud, each gasket and nut capable of securely retaining each light fixture on each stud and each stud, nut and gasket forming a watertight mechanical joint,
c) a top cover mountable to an upper portion of the connector bracket, a gasket forming a watertight seal between the connector bracket and top cover,
d) the top cover including snap clips on an exterior side of the top cover, each of the plurality of housing attachments including snap clips on an exterior side of housing attachments, the snap clips of the top cover engagable to the snap clips on each of the plurality of housing attachments,
a mechanical joint including a conduit lock nut capable of being installed under the top cover and a gasket, a watertight conduit and conduit nut capable of being installed above the top cover, the mechanical joint mechanically connecting the top cover to a top cover of a junction box, the top cover of a junction box capable of being connected to the junction box at the installation location, and
f) a canopy attachable to the top cover and connector bracket and rotatably engagable to the top cover of the junction box.

15. The method of using the light fixture installation kit of claim 14, the method further comprising:
a) the plurality of light fixtures and the plurality of housing attachments are assembled at any location as an assembly for each of the plurality of light fixtures,
b) the assembly for each of the plurality of light fixtures assembled at any location is transported to the installation location,
c) the single manual electrical connection to the plurality of light fixture assemblies is made-up below the top cover through the mechanical joint, this same electrical connection is also capable of being connected to wiring in the junction box which receives a power supply from an external power source,
d) after the single manual electrical connection is made-up, the upper portion of the mechanical joint including the gasket, watertight conduit and conduit nut are installed to the junction box top cover,
e) after the upper portion of the mechanical joint is installed to the top cover of the junction box, the lower portion of the mechanical joint consisting of the conduit lock nut is installed under the top cover,
f) after the lower portion of the mechanical joint is installed to the top cover, fasteners which connect the canopy, top cover and the connector bracket are installed,
g) after installation of the canopy to the top cover and connector bracket, the canopy is rotatably engaged to the top cover of the junction box,
h) after installation of the canopy to the top cover of the junction box, the assembly assembled at any location for each of the plurality of light fixtures is mechanically connectable to the connector bracket by connecting the male connector in the housing assembly to the corresponding female connector in the connector bracket,
i) to complete the installation of the plurality of light fixtures installed utilizing the light fixture installation kit requiring only a single manual electrical connection, the assembly assembled at any location for each of the plurality of light fixtures is mechanically connectable to the top cover by engaging snap clips located on the housing attachment to the snap clips located on the top cover.

16. A lighting fixture installation system comprising:
first and second housings, each of the first and second housings enclosing first and second male connectors,
the first and second male connectors are capable of being electrically connected to first and second lighting systems,
first and second female connectors, the first and second male connectors capable of being connected to the first and second female connectors,
the female connectors are capable of being electrically connected to a power source,
each of the first and second male connectors are capable of being electrically connected to one of a first and second light fixture,
whereby the first and second male connectors connectable to the first and second female connectors form a first and second mechanical and electrical joint, whereby a line passing through an axis of symmetry of each of the first and second mechanical and electrical joints is oriented in a vertical direction when each of the first and second mechanical and electrical joints are made-up.

17. The lighting fixture installation system of claim 16, whereby the first and second lighting systems are electrically connected to the power source using the first and second mechanical and electrical joints.

18. The lighting fixture installation system of claim 17, whereby when the first and second mechanical and electrical joints are dismantled, each of the first and second housings and one of the first and second light fixtures are mechanically connected to each other and are capable of being removed as a unit.

19. The lighting fixture installation system of claim 18, whereby an end of the first and second lighting systems are supported at an end distal to the first and second male connectors by first and second mounting clips.

20. The lighting fixture installation system of claim 16, whereby the first and second mechanical and electrical joints form a watertight connection.

21. The lighting fixture installation system of claim 16, whereby each of the first and second lighting systems may be connected or disconnected from the first and second mechanical and electrical joints at an off-site location prior to installation.
